(19) United States
(12) Patent Application Publication
(10) Pub. No.: US 2025/0035734 A1
(43) Pub. Date: Jan. 30, 2025

(54) LOCALIZATION OF EXTERNAL SOUND SOURCES BY MEANS OF ULTRASONIC SENSOR ARRAYS

(71) Applicant: Robert Bosch GmbH, Stuttgart (DE)

(72) Inventors: Michael Schumann, Stuttgart (DE); Alexander Menk, Leonberg (DE); Dirk Schmid, Simmozheim (DE)

(21) Appl. No.: 18/716,370

(22) PCT Filed: Nov. 21, 2022
(86) PCT No.: PCT/EP2022/082569

§ 371 Date: Jun. 4, 2024

(30) Foreign Application Priority Data
Dec. 13, 2021 (DE) 10 2021 214 178.1

(51) Int. Cl. G01S 5/20

(52) U.S. Cl. CPC G01S 5/20; G01S 2205/01

(57) ABSTRACT

A method for localizing at least one sound source using at least two ultrasonic sensor arrays, which each have at least two transducer elements for receiving sound waves. The transducer elements receive sound waves and generate electrical signals representing the received sound waves. At least one phase offset between the at least two electrical signals is ascertained. The sound source is located by triangulation on the basis of the ascertained phase offsets between the electrical signals and a distance a between the ultrasonic sensor arrays. A control device, a computer program, and a machine-readable storage medium, are also described.

### FIELD

The present invention relates to a method for localizing at least one external sound source by means of at least two ultrasonic sensor arrays, which each have at least two transducer elements for receiving sound waves. The present invention further relates to a control device, to a computer program and to a machine-readable storage medium.

### BACKGROUND INFORMATION

Ultrasound-based localization of objects in the vehicle environment usually takes place via trilateration. For this purpose, a plurality of ultrasonic sensors designed as so-called bulk sensors are used to measure a corresponding distance to an object. Localization takes place by forming circle intersections or by forming ellipse intersection points in pure receivers. Sound-emitting objects that are outside the detection area cannot be localized using this method. All objects for which the reflected echo signal can no longer be separated from the received noise of the ultrasonic sensor are outside the detection area. Under optimal conditions or without sources of interference, these limits for current ultrasonic sensors are approximately 5-7 m. However, if other acoustic sources are present near the ultrasonic sensor, the range can drop to less than 1 m. This susceptibility to interference thus prevents the efficient use of ultrasonic sensors in the vehicle environment for environmental monitoring that goes beyond parking assistance. The neighboring road users, such as motorcycles, trucks, which are often present in the vehicle environment, and other sound sources, such as construction sites or construction site noise, can thus limit the area of application of the ultrasonic sensors.

A problem with such limitations is that, for example, ultrasound-based assistance functions, such as blind spot monitoring or adjacent lane recognition cannot be reliably implemented in all traffic situations, in particular because the external sound source causes an increase in sensor noise, which prevents localization of the sound source.

German Patent Application No. DE 10 2018 205 661 A1 describes a method for locating external sound sources in a vehicle, in which a sound signal is registered and evaluated by a plurality of bulk ultrasonic sensors. A method for localizing an external sound source by means of a microphone, which is implemented on the basis of Doppler calculations, is also described in German Patent Application No. DE 10 2018 222 862 A1.

### SUMMARY

An object of the present invention includes providing a method for localizing objects even under disturbed conditions.

This object may be achieved by means of features of the present invention. Advantageous embodiments of the present invention are disclosed herein.

According to one aspect of the present invention, a method for localizing at least one external sound source by means of at least two ultrasonic sensor arrays is provided. The external sound source is preferably located outside a mobile unit that also has the at least one ultrasonic sensor array. The ultrasonic sensor arrays each have at least two transducer elements for receiving sound waves. In one step, the transducer elements receive sound waves, in particular from external sound sources, and generate electrical signals representing the received sound waves.

Depending on the design of the ultrasonic sensor array, the transducer elements can be configured to send and/or receive sound waves.

The generated electrical signals can be received and evaluated independently of one another by a control device. In particular, the electrical signals can be stored at least temporarily in the form of digital data in a memory of the control device or in an external memory.

According to an example embodiment of the present invention, within the scope of an evaluation of the electrical signals, at least one phase offset between the in each case at least two electrical signals is ascertained for each ultrasonic sensor array.

Relative angles between the respective ultrasonic sensor arrays and the sound source can be determined from the phase offsets.

For example, as the angle between an ultrasonic sensor array increases, the resulting phase offset between the electrical signals also increases. An angle can thus be determined from an ascertained phase offset by means of a characteristic curve created in advance or by means of a mathematical model.

On the basis of the ascertained phase offsets between the electrical signals and a distance between the ultrasonic sensor arrays, the external sound source is located by triangulation. In particular, a relative distance and a relative direction can be calculated or at least estimated.

According to an example embodiment of the present invention, alternatively, the external sound source can be located by triangulation on the basis of ascertained angles between the at least two ultrasonic sensor arrays and at least one distance between the ultrasonic sensor arrays.

According to an example embodiment of the present invention, alternatively or additionally, a fixed phase offset can be specified or examined with regard to the presence of sound sources. In particular, various phase offsets can thus be checked sequentially or simultaneously in order to scan a solid angle range for external sound sources.

By knowing the distance and the direction of the spacing of the particular transducer elements, the direction from which the sound sources are emitted can be determined precisely. In particular, for each ascertained phase offset, a direction or an angle between the corresponding ultrasonic sensor array and the external sound source can be determined. Two ultrasonic sensor arrays having a known distance from one another make it possible to precisely determine the position of the sound source.

The method according to the present invention thus makes it possible to increase the range for the ultrasound-based detection and localization of sound-emitting objects, such as vehicles, construction machines, manufacturing systems, transport systems and the like.

According to a further aspect of the present invention, a control device is provided, wherein the control device is configured to carry out the method. The control device can be, for example, an on-board control device, an off-board control device, or an off-board server unit such as a cloud system. The control device can preferably receive and evaluate the electrical signals in the form of measurement data from the transducer elements individually.

Preferably, the position of the transducer elements and the position of the at least two ultrasonic sensor arrays relative to one another are stored in the control device or corresponding memory in order to carry out a triangulation method.

Furthermore, according to one aspect of the present invention, a computer program is provided which comprises commands which, when the computer program is executed by a computer or a control device, cause same to carry out the method according to the present invention. According to a further aspect of the present invention, a machine-readable storage medium is provided, on which the computer program according to the present invention is stored.

The control device and/or the at least two ultrasonic sensor arrays can, for example, be arranged in a mobile unit which can be operated in an assisted, partially automated, highly automated and/or fully automated or driverless manner in accordance with the BASt standard.

For example, the mobile unit may be designed as a vehicle, a robot, a drone, a watercraft, a rail vehicle, a robotaxi, an industrial robot, a commercial vehicle, a bus, an aircraft, a helicopter and the like.

The method of the present invention makes it possible to realize the determination of the direction of an external sound source by means of at least two multi-element sensors or ultrasonic sensor arrays, each having a plurality of transducer elements. In the process, a position of the external sound source can also be ascertained by combining the angle results of a plurality of ultrasonic sensor arrays via triangulation. For this purpose, the object position or the position of the external sound source can be calculated from a known or ascertained angle and from a known base distance between the particular transducer elements.

The direction or an angle of an external sound source can be ascertained by means of the phase offset between the transducer elements, or receiving elements, receiving the sound waves.

In particular, the method of the present invention can be used to implement a blind spot assistant, adjacent lane monitoring, monitoring of preceding or following vehicles and the like on the basis of measurements from ultrasonic sensor arrays. The method is not limited to use in vehicles and can be used alternatively or additionally in processing systems, in production systems, in the transport sector, in the security sector and the like to localize external sound sources even in the presence of sources of interference.

In one exemplary embodiment of the present invention, the generated electrical signals are checked, in particular filtered, with regard to different phase offsets. By means of this measure, different phase offsets, which correspond to different angles of incidence from which sound waves can reach the transducer elements, are scanned for incoming sound waves. Specific angle ranges or solid angle ranges can thus be checked with regard to the existence of sound sources.

According to a further embodiment of the present invention, a phase offset is ascertained according to an alignment of the at least two transducer elements along a height direction, along a longitudinal direction and/or along a transverse direction. This makes it possible to localize the at least one external sound source independently of its direction or position relative to the ultrasonic sensor array. The method is thus also suitable for applications involving height differences, for example in the case of drones or in the case of cranes.

According to a further exemplary embodiment of the present invention, the transducer elements substantially have a distance of at least half a wavelength of an ultrasonic frequency. Preferably, a relative angle of the sound source is ascertained on the basis of the phase offset of the generated electrical signals and the distance between the transducer elements. In order to reduce the influence of side lobes, the receiving elements or the receiving transducer elements must be located at a distance of approximately lambda/2. Lambda corresponds to the wavelength of the received sound waves. The received sound waves can have a wavelength or frequency that is within the ultrasonic range or outside the ultrasonic range.

According to a further embodiment of the present invention, at least one external sound source formed as an engine, a compressor, a fan, an exhaust system, in particular exhaust, an external ultrasonic sensor, a passenger loudspeaker, a braking noise, an acoustic signal generator and/or as a rolling noise of wheels on a dry or wet road is localized by means of the at least one ultrasonic sensor array. The various external sound sources thus no longer act as sources of interference for the ultrasound-based localization of objects. Rather, the external sound sources are used beneficially for the localization.

According to a further embodiment of the present invention, the phase offsets between the generated electrical signals and the triangulation are ascertained continuously, at fixed or variable time intervals, when a level is exceeded by at least one electrical signal, and/or as needed, in particular as needed by a control device. This measure makes it possible to initiate the evaluation and, optionally, the reception of the electrical signals in a variety of ways on the basis of different triggers.

Preferred exemplary embodiments of the present invention are explained in more detail below with reference to highly simplified schematic representations.

### BRIEF DESCRIPTION OF THE DRAWINGS

FIG. 1 is a flowchart for illustrating a method according to an example embodiment of the present invention.

FIG. 2 shows a vehicle arrangement for illustrating an application of the method in a blind spot assistant, according to an example embodiment of the present invention.

FIG. 3 shows a vehicle arrangement for illustrating an application of the method in adjacent lane monitoring, according to an example embodiment of the present invention.

FIG. 4 shows a vehicle arrangement for illustrating an application of the method when monitoring a preceding or following road user, according to an example embodiment of the present invention.

### DETAILED DESCRIPTION OF EXAMPLE EMBODIMENTS

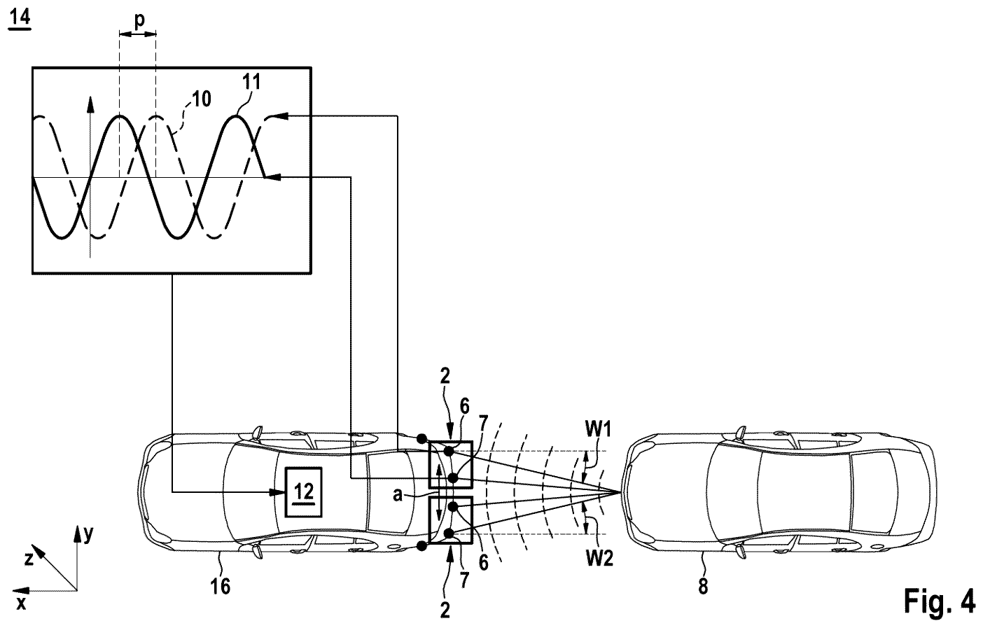

FIG. 1 is a flowchart for illustrating a method 1 according to an embodiment. The method 1 is used to localize at least one sound source 4 by means of at least one ultrasonic sensor array 2, which has at least two transducer elements 6, 7 for receiving sound waves. The corresponding components are shown in detail in FIG. 4 by way of example.

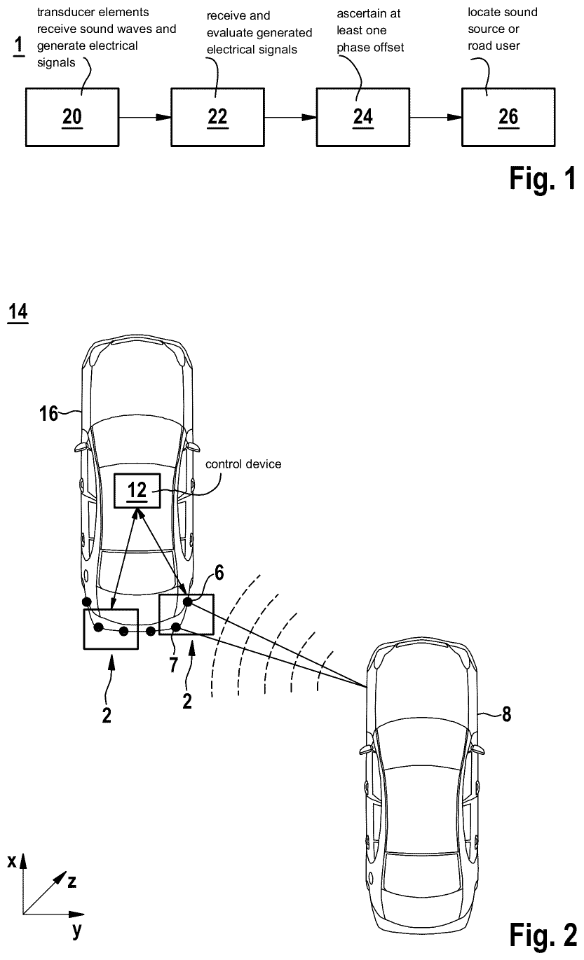

In one step 20, the transducer elements 6, 7 receive sound waves, in particular from external sound sources 4, and generate electrical signals 10, 11 representing the received sound waves. The external sound sources 4 are, by way of example, components of mobile units 8 designed as road users 8 or passenger cars. In particular, the sound source 4 is shown, by way of example, in the form of engines or exhaust systems in FIG. 2 to 4. However, the method 1 is not limited to use in vehicles or to traffic situations and can generally be used in mobile units 8 that are designed as rail vehicles, watercraft, land vehicles or aircraft. In addition, mobile units may also be robots or manufacturing systems.

The generated electrical signals 10, 11 can be received and evaluated 22 independently of one another by a control device 12. In particular, the electrical signals 10 can be stored at least temporarily in the form of digital data in a memory (not shown) of the control device 10 or in an external memory.

Within the scope of an evaluation 22 of the electrical signals 10, at least one phase offset p between the electrical signals of the at least two transducer elements 6, 7 is ascertained 24. The corresponding relationships between the control device 12 and the transducer elements 6, 7 of the ultrasonic array 2 are illustrated in FIG. 4.

On the basis of the ascertained phase offset p between the electrical signals 10, 11 and a distance a between the transducer elements 6, 7 of the ultrasonic sensor array, a relative angle W1, W2 is ascertained, which indicates a direction of the sound source 4. Each ultrasonic sensor array 2 can thus ascertain an angle W1, W2. On the basis of the ascertainment of at least two angles W1, W1, W2 and a known distance a between the ascertaining ultrasonic sensor arrays 2, the sound source 4 can be located 26 by triangulation. In particular, in FIG. 2 to 4, an engine of the road user 8 is the sound source 4, the sound waves of which are received by the transducer elements 6, 7 of the, for example, two ultrasonic sensor arrays 2.

Locating 26 the sound source 4 or the road user 8 can comprise ascertaining an absolute position, a relative position of the sound source 4 with respect to the ultrasonic sensor array 2, or ascertaining a relative direction or a relative angle w of the sound source 4 with respect to the ultrasonic sensor array 2.

Alternatively or additionally, a fixed phase offset p can be specified or examined with regard to the presence of sound sources 4. In particular, various phase offsets p can thus be checked sequentially or simultaneously in order to scan a solid angle range for external sound sources 4.

FIG. 2 shows a vehicle arrangement 14 for illustrating an application of the method 1 in a blind spot assistant. The vehicle arrangement 14 has an ego vehicle 16, which comprises two exemplary ultrasonic sensor arrays 2 in a rear area. The ultrasonic sensor arrays 2 each have two transducer elements 6, 7, which are spaced apart from one another along a transverse direction x. The ultrasonic sensor arrays 2 can have any number of transducer elements 6, 7, which, depending on the alignment, are alternatively spaced from one another along a longitudinal direction, which is a driving direction x in the exemplary embodiment shown, and/or along a height direction z. Through this spacing of the transducer elements 6, 7 and a known spacing Substitute Specification of the ultrasonic sensor arrays 2 from one another, a triangulation method can be applied in order to realize a localization of external sound sources 4.

In the exemplary embodiment shown, a neighboring vehicle or a neighboring road user 8 is formed as a sound source 4. The engine, a rolling noise of the tires and the like can act as the actual sound source 4, which is detectable by the ultrasonic sensor arrays 2.

The particular transducer elements 6, 7 are individually connected to a control device 12 and can be evaluated and controlled by the control device 12. In particular, the transducer elements 6, 7 can be operated selectively in a reception mode or in a transmission mode by the control device 12 in order to receive sound waves.

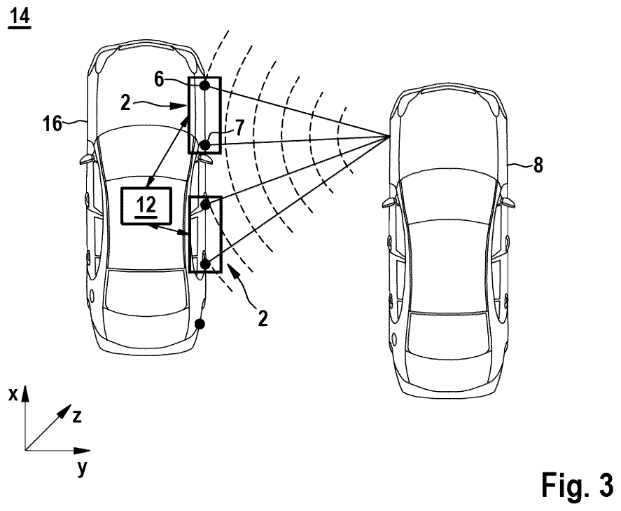

FIG. 3 shows a vehicle arrangement 14 for illustrating an application of the method 1 in adjacent lane monitoring. To the right of the ego vehicle 16 is a road user 8, which can be registered and tracked by the exemplary two ultrasonic sensor arrays 2.

Through the use of at least two ultrasonic sensor arrays 2, the control device 12 can check whether it is possible to return to a lane after an overtaking maneuver or whether the adjacent lane is free for changing lanes to perform an overtaking maneuver.

FIG. 4 shows a vehicle arrangement 14 for illustrating an application of the method 1 when monitoring a preceding or following road user 8. As already noted in FIG. 1, FIG. 4 illustrates in detail the electrical signals 10, 11, which are generated by the transducer elements 6, 7 within the scope of monitoring a following road user 8. This takes place separately for each of the two exemplary ultrasonic sensor arrays 2.

The particular transducer elements 6, 7 receive the sound waves from a certain angle or from different angles. A reception angle of a first transducer element 6 deviates slightly from a reception angle of a second transducer element 7. This deviation results in the phase offset p, which is ascertained in a subsequent evaluation by the control device 12. The angles W1, W2 can be calculated from the phase offset p. Each ultrasonic sensor array 2 ascertains a phase offset p, which can be converted into a corresponding angle W1, W2. Two angles W1, W2 can thus be determined, wherein a distance a between the ultrasonic sensor arrays 2 is usually known or can be measured in advance. By means of two angles W1, W2 and the distance a, the triangulation method can be carried out and the relative position of the sound source 4 can be calculated.

The at least one ultrasonic sensor array 2 can preferably be produced in MEMS technology and, for example, be designed as a so-called piezoelectric micromachined ultrasonic transducer (PMUT sensor). The transducer elements 6, 7 can be designed as membranes or as vibrating pistons or as combined membrane-piston assemblies in order to generate and/or receive acoustic pulses or sound waves.

In addition to the localization of the sound source 4, the presence of a sound source 4 within a detection area of the at least one ultrasonic sensor array 2 can alternatively also be registered in the process. It is possible to register the presence of the sound source 8 at a distance of 5-7 m from the ultrasonic sensor array 2 or the transducer elements 6, 7.

1-9. (canceled)

10. A method for localizing at least one external sound source which is arranged outside a mobile unit, using at least two ultrasonic sensor arrays which each have at least two transducer elements for receiving sound waves, the method comprising:
receiving, using the transducer elements, sound waves, and generating, using the transducer elements, electrical signals representing the received sound waves;
ascertaining, for each respective ultrasonic sensor array of the at least two ultrasonic sensor arrays, at least one phase offset between at least two electrical signals generated by the tranducer elements of the respective ultrasonic sensor array; and
locating the external sound source by triangulation based on the ascertained phase offsets between the electrical signals and a distance between the ultrasonic sensor arrays.

11. The method according to claim 10, wherein the generated electrical signals are filtered with regard to different phase offsets.

12. The method according to claim 10, wherein each of the phase offsets is ascertained according to an alignment of the at least two transducer elements of the respective ultrasonic sensor array along a height direction, and/or along a longitudinal direction, and/or along a transverse direction.

13. The method according to claim 10, wherein the transducer elements of each respective ultrasonic sensor array are at a distance from one another of half a wavelength of a sound frequency, wherein a relative angle to the sound source is ascertained based on the phase offset of the generated electrical signals and the distance between the transducer elements.

14. The method according to claim 10, wherein the external sound source is an engine or a compressor or a fan or an exhaust system or an external ultrasonic sensor or a passenger loudspeaker or a brake or an acoustic signal generator or rolling wheels and is localized using at least one ultrasonic sensor array.

15. The method according to claim 10, wherein the phase offsets between the generated electrical signals and the triangulation are carried out continuously, at fixed or variable time intervals, when a level is exceeded by at least one electrical signal.

16. A control device configured to localize at least one external sound source which is arranged outside a mobile unit, using at least two ultrasonic sensor arrays which each have at least two transducer elements for receiving sound waves, the method comprising:
receiving, using the transducer elements, sound waves, and generating, using the transducer elements, electrical signals representing the received sound waves;
ascertaining, for each respective ultrasonic sensor array of the at least two ultrasonic sensor arrays, at least one phase offset between at least two electrical signals generated by the tranducer elements of the respective ultrasonic sensor array; and
locating the external sound source by triangulation based on the ascertained phase offsets between the electrical signals and a distance between the ultrasonic sensor arrays.

17. A non-transitory machine-readable storage medium on which is stored a computer program for localizing at least one external sound source which is arranged outside a mobile unit, using at least two ultrasonic sensor arrays which each have at least two transducer elements for receiving sound waves, the computer program, when executed by a computer, causing the computer to perform the following steps:
receiving, using the transducer elements, sound waves, and generating, using the transducer elements, electrical signals representing the received sound waves;
ascertaining, for each respective ultrasonic sensor array of the at least two ultrasonic sensor arrays, at least one phase offset between at least two electrical signals generated by the tranducer elements of the respective ultrasonic sensor array; and
locating the external sound source by triangulation based on the ascertained phase offsets between the electrical signals and a distance between the ultrasonic sensor arrays.
